(19) United States
(12) Patent Application Publication
(10) Pub. No.: US 2013/0271438 A1
(43) Pub. Date: Oct. 17, 2013

(54) INTEGRATED AMBIENT LIGHT SENSOR

(71) Applicant: Koorosh Aflatooni, Cupertino, CA (US)

(72) Inventor: Koorosh Aflatooni, Cupertino, CA (US)

(73) Assignee: QUALCOMM MEMS TECHNOLOGIES, INC., San Diego, CA (US)

(21) Appl. No.: 13/446,959

(22) Filed: Apr. 13, 2012

(51) Int. Cl. G06F 3/038

(52) U.S. Cl. 345/207; 29/825

(57) ABSTRACT

For a personal electronic device (PED) having a display, the display including a cover glass having a front surface and a back surface, the PED includes a driver circuit configured to send at least one signal to the display and an ambient light sensor (ALS). Each of the driver circuit and the ALS is disposed behind the back surface of the cover glass. The ALS and the driver circuit may reside on a single substrate, which is disposed adjacent to the back surface of the cover glass. The ALS may output signals to the driver circuit that are indicative of ambient light level and one or both of ambient light spectrum and ambient light direction. The driver circuit may be configured to automatically adjust, in response to the signals, one or both of a display color bias and a display luminescence.

### TECHNICAL FIELD

This disclosure relates to ambient light sensors for a personal electronic device having a display, and, more specifically, to an ambient light sensor integrated behind a cover glass of the display and configured to output signals indicative of a spectrum and directionality of ambient light.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities, such as personal computers and personal electronic devices (PED's).

Conventional PED's often incorporate at least one ambient light sensor (ALS) that outputs a signal indicative of the intensity of ambient light. In response to that signal, the luminescence of the PED display may be varied by, for example, one or more driver circuits. The ALS is conventionally mounted on a frame of the PED near, but not on, a cover glass of the PED display. As a result, additional space on the frame has to be reserved for the ALS, and associated electrical connections must be provided from the ALS to display driver circuits. Moreover, because the ALS signal is indicative only of level of the ambient light, driver circuits are unable to compensate a display color bias or luminescence in response to the spectrum or direction of the ambient light.

As a result, improvements in the functionality of the ALS, while reducing penalties associated with its footprint and integration complexity, are desirable.

### SUMMARY

The systems, methods and devices of the disclosure each have several innovative aspects, no single one of which is solely responsible for the desirable attributes disclosed herein.

One innovative aspect of the subject matter described in this disclosure may be implemented in a personal electronic device (PED) having a display, the display including a cover glass having a front surface and a back surface. The PED includes a processor that is configured to communicate with the display, the processor being configured to process image data, a driver circuit configured to send at least one signal to the display, and an ambient light sensor (ALS). Each of the driver circuit and the ALS is disposed behind the back surface of the cover glass. The ALS is configured to output signals indicative of a level, spectrum and directionality of ambient light.

In some implementations the ALS and the driver circuit may reside on a single substrate disposed proximate to the back surface of the cover glass. The ALS may be integrated with the driver circuit. An anisotropic conductive film may adhere the driver circuit to the back surface of the cover glass.

One or both of the driver circuit and the processor may be configured to automatically adjust, in response to the signals, one or both of a display color bias and a display luminescence.

The ALS may include at least two photosensitive elements, each photosensitive element having a different respective sensitivity to a respective spectrum of electromagnetic radiation. Each of the at least two photosensitive elements may be respectively tuned for sensitivity to a respective spectrum of electromagnetic radiation by way of a varied depth of a respective photodiode depletion region.

The PED may include at least a first ALS and a second ALS, each disposed proximate to at least one mask element, the mask element configured such that, for ambient light having a first directional component, the first ALS and the second ALS receive light of a substantially different intensity. The PED may include a first mask element, and a second mask element, disposed in a cruciform arrangement in a first plane substantially parallel to the back surface of the cover glass, the plane disposed so that a beam of incoming ambient light must cross the plane before reaching the first ALS or the second ALS. The PED may include a third ALS, a first mask element, a second mask element, and a third mask element disposed in a three legged star arrangement in a first plane substantially parallel to the back surface of the cover glass, the plane disposed so that a beam of incoming ambient light must cross the plane before reaching the first ALS, the second ALS, or the third ALS.

The PED may include at least a first ALS, a second ALS, and a third ALS, each disposed proximate to at least one respective mask element, the mask element configured such that, for ambient light having a first directional component, at least two of the first ALS, the second ALS, and the third ALS receive light of a substantially different intensity.

In some implementations, an apparatus includes means for receiving signals output by at least one ambient light sensor (ALS), wherein the signals are indicative of ambient light level and one or both of ambient light spectrum and ambient light direction. A driver circuit is configured to send at least one signal to a display and to automatically adjust, in response to the received signals, one or both of a display color bias and a display luminescence of the display. The display includes a cover glass, the cover glass having a front surface and a back surface. Each of the driver circuit and the ALS is disposed behind the back surface of the cover glass.

In some implementations, a method includes receiving signals output by at least one ambient light sensor (ALS), wherein the signals are indicative of ambient light level and one or both of ambient light spectrum and ambient light direction; and automatically adjusting, with a driver circuit, responsive to the received signals, one or both of a display color bias and a display luminescence of a display of a personal electronic device (PED). The display may include a cover glass, the cover glass having a front surface and a back surface. In some implementations, the at least one ALS is integrated with the driver circuit and disposed behind the back surface of the cover glass.

In some implementations, a method includes forming a display, the display including a cover glass having a front surface and a back surface; disposing, on the back surface of the cover glass, a driver circuit configured to send at least one signal to the display and at least one ambient light sensor (ALS). The ALS is configured to output signals indicative of ambient light level and one or both of ambient light spectrum and ambient light direction. The driver circuit is configured to automatically adjust, responsive to the received signals, one or both of a display color bias and a display luminescence of the display.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIGS. 9A-9C show an example of a PED in accordance with one implementation.

FIGS. 10A and 10B show an example of a PED in accordance with an implementation where an ALS is proximate to at least one of the driver circuits.

FIG. 11 shows an example of an implementation where an ALS is disposed behind a lens.

FIGS. 12A-12E show examples of implementations configured to detect a directionality of incoming light.

FIG. 13 shows an example of a method for adjusting a display parameter based on analysis of signals output from photosensitive elements.

FIGS. 14A and 14B show examples of an implementation of an ALS configured to detect a spectrum characteristic of ambient light.

FIG. 15 shows an example of a method for adjusting at least one display parameter based on analysis of signals output from photosensitive elements configured to output signals indicative of a spectrum of incoming light.

FIG. 16 shows an example of a method for adjusting a display color bias and/or display luminescence of a display of a PED.

FIG. 17 shows an example of a method for fabricating a display.

FIGS. 18A and 18B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Described herein below are new techniques incorporating a personal electronic device having a display, a driver circuit and an ambient light sensor (ALS). The display includes a cover glass having a front surface and a back surface. The driver circuit is configured to send at least one signal to the display. The ALS and each driver circuit are disposed behind the back surface of the cover glass. The ALS outputs signals to the driver circuit and/or processor, the signals being indicative of a level, spectrum and directionality of ambient light direction. In response to those signals, a characteristic of the display may be adjusted or optimized. For example, a color bias of the display, or a display luminescence may be adjusted. In some implementations, the ALS and the driver circuit reside on a single semiconductor substrate, which is disposed adjacent to the back surface of the cover glass. Advantageously, the driver circuit and ALS may be implemented as a monolithic integrated circuit.

Particular implementations of the subject matter described in this disclosure can be implemented to realize one or more of the following potential advantages. Because each of the driver circuit and the ALS are disposed behind the cover glass, the overall dimension of the PED may be reduced. For example, in accordance with the present teachings, a need to reserve mounting space for the ALS outside a perimeter of the cover glass (i.e., on a surrounding “frame” of the PED) may be avoided. Moreover, the present techniques simplify electrical integration by avoiding a necessity to provide for electrical connection between a frame-mounted ALS and a cover-glass-mounted driver circuit. In addition, for implementations where the ALS and the driver circuit reside on a single substrate, less masking is needed.

Additional advantages include enhanced control of display parameters based on improved ALS functionality. For example, the ALS may be configured to output signals indicative of one or both of a direction and a spectrum of ambient light, in addition to an indication of an intensity, or level, of ambient light. In response to the ALS output signals, display performance may be optimized by, for example, adjusting color mapping, color bias or luminescence of the display.

Although much of the description herein pertains to interferometric modulator displays, many such implementations could be used to advantage in other types of reflective displays, including but not limited to electrophoretic ink displays and displays based on electrowetting technology. Moreover, while the interferometric modulator displays described herein generally include red, blue and green pixels, many implementations described herein could be used in reflective displays having other colors of pixels, e.g., having violet, yellow-orange and yellow-green pixels. Moreover, many implementations described herein could be used in reflective displays having more colors of pixels, such as, for example, having pixels corresponding to 4, 5, or more colors. Some such implementations may include pixels corresponding to red, blue, green and yellow. Alternative implementations may include pixels corresponding to red, blue, green, yellow and cyan.

An example of a suitable device, to which the described implementations may apply, is a reflective EMS or MEMS-based display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

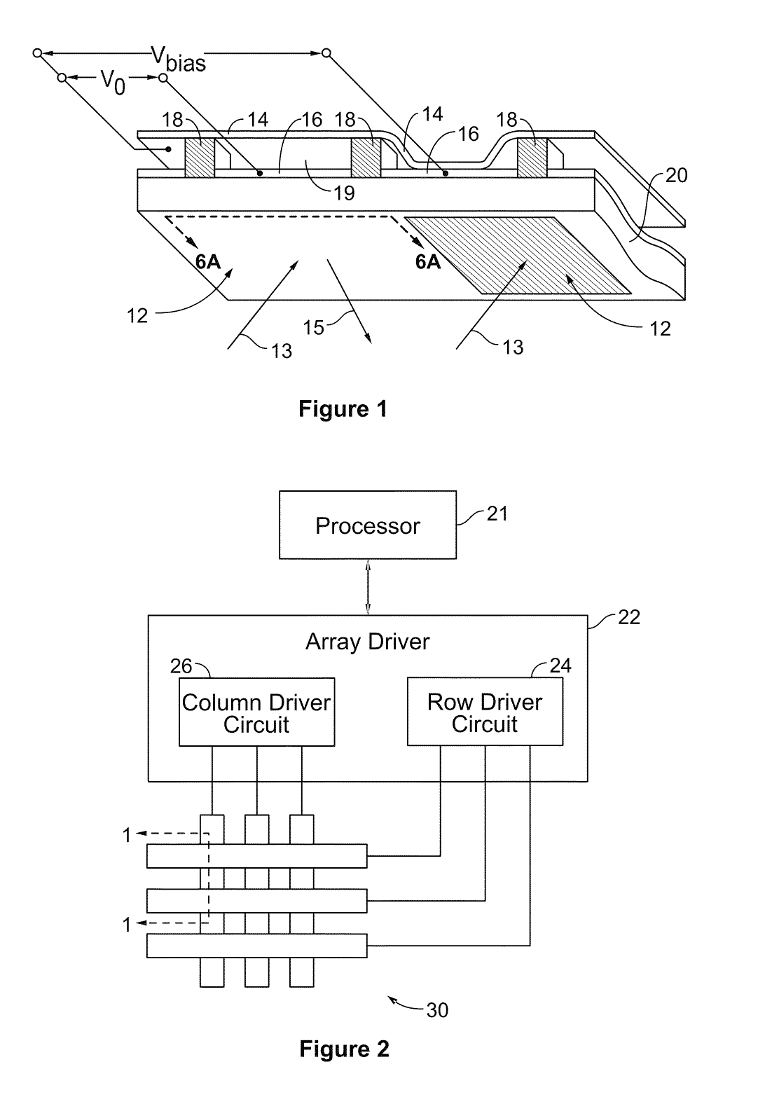

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

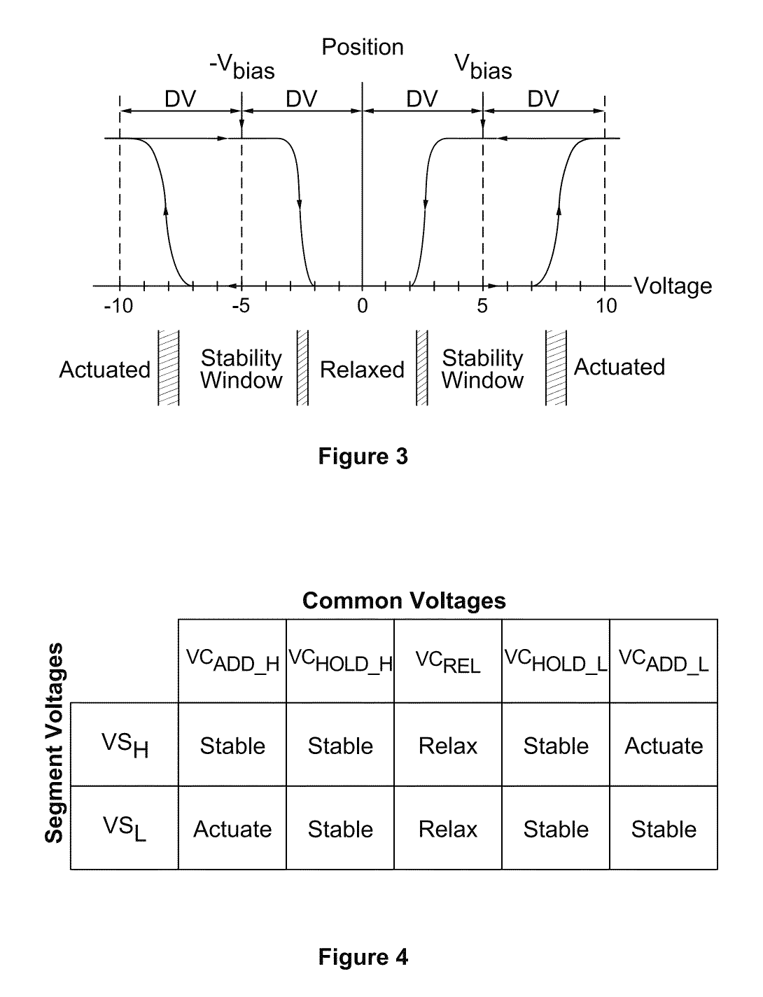

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts; however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

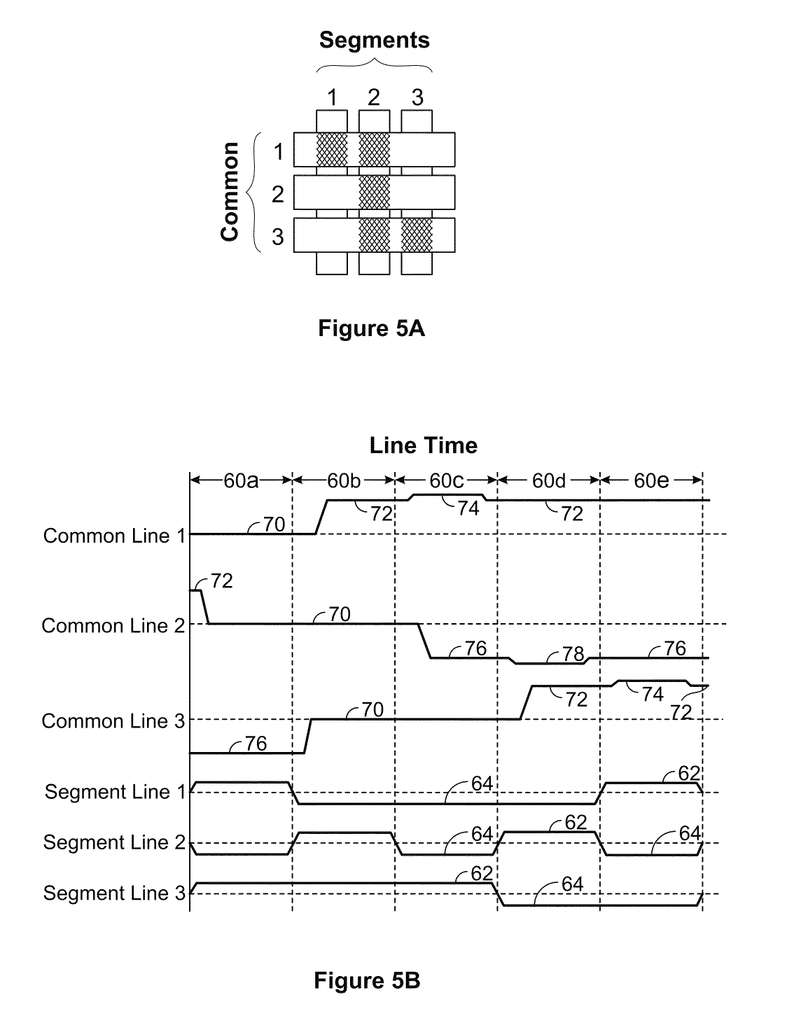

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

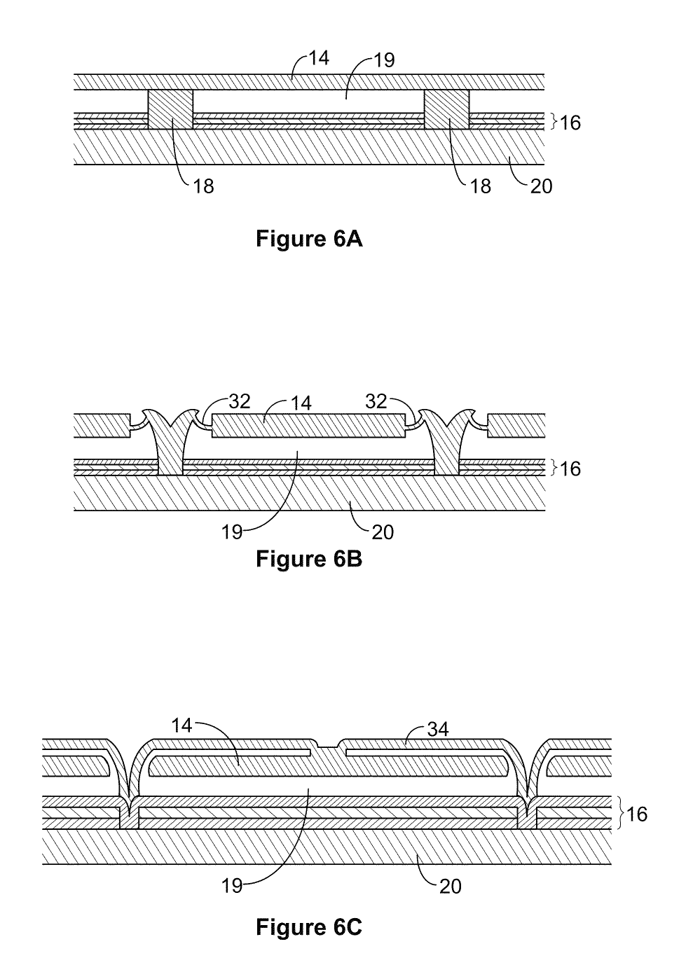

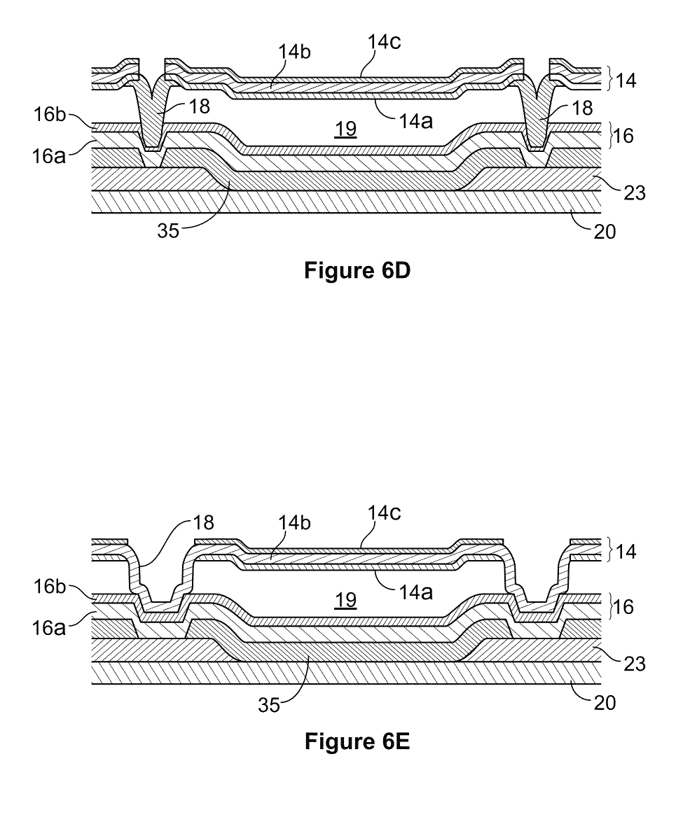

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

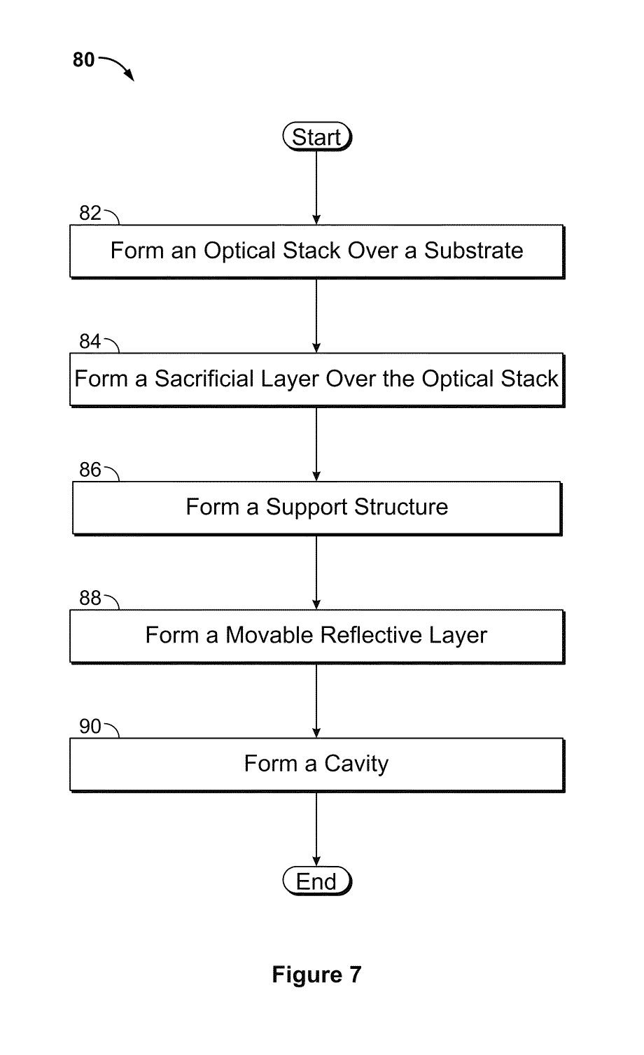

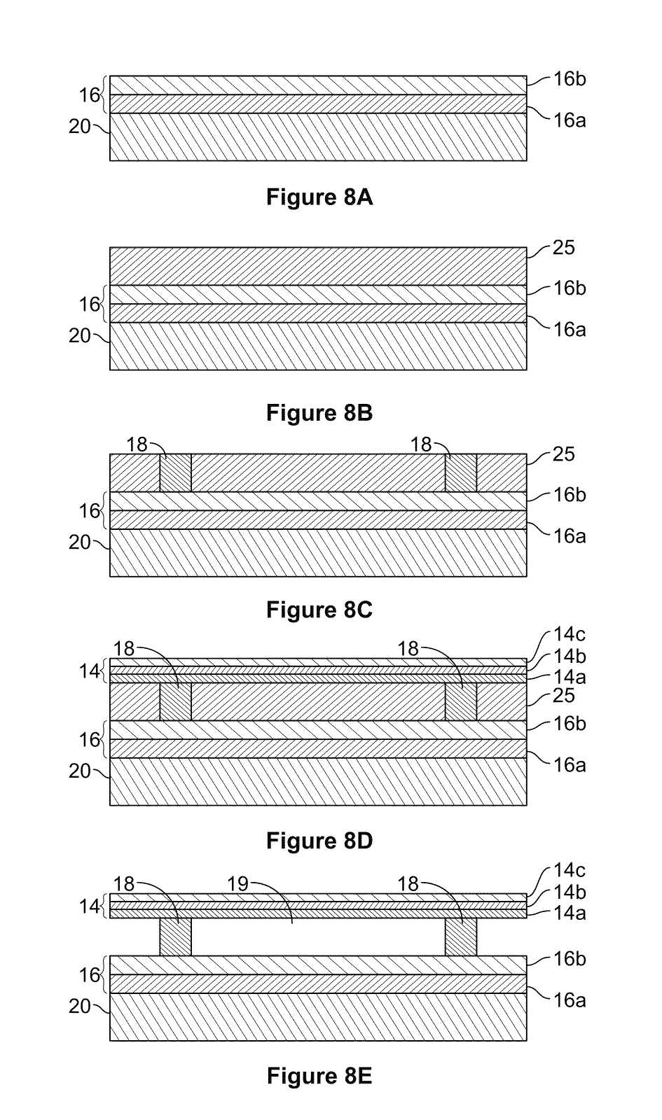

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

According to one innovative aspect of the subject matter described in this disclosure, a personal electronic device (PED), which may include an IMOD display device as described hereinabove, has a display, a driver circuit and an ambient light sensor (ALS). The display includes a cover glass having a front surface and a back surface. The driver circuit is configured to send at least one signal to the display. The ALS and each of the driver circuit are disposed behind the back surface of the cover glass. The ALS may output signals that are indicative of ambient light spectrum and ambient light direction. Advantageously, the ALS and the driver circuit may reside on a single substrate, which is disposed adjacent to the back surface of the cover glass. In other words, the ALS and the driver circuit may be monolithically integrated onto the same silicon substrate.

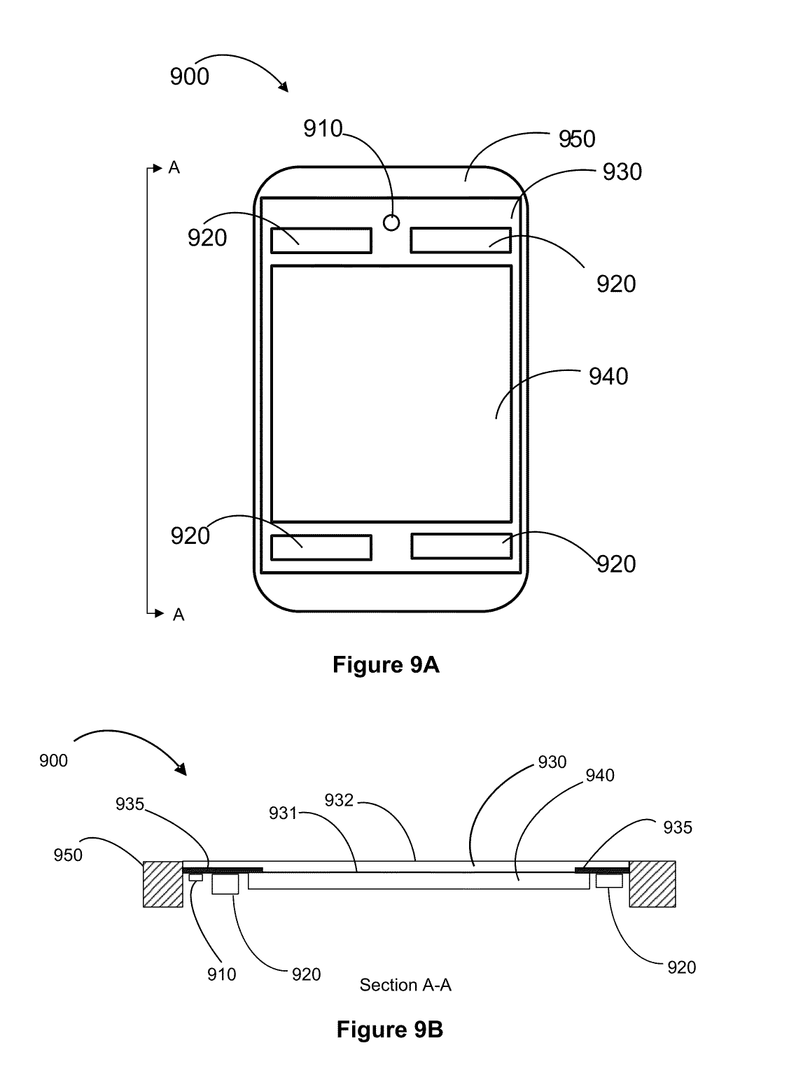

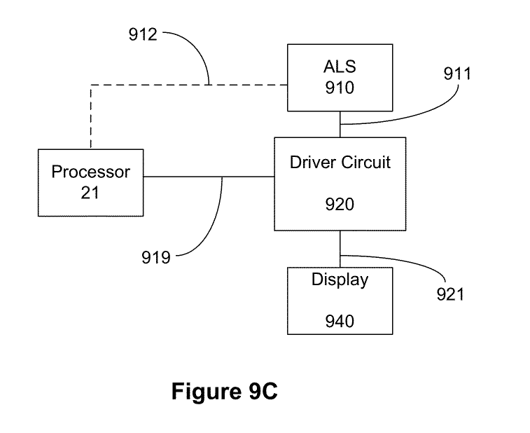

FIGS. 9A-9C show an example of a PED in accordance with one implementation. Referring to FIG. 9A, a plan view of PED 900 in accordance with one implementation is illustrated. It will be understood that PED 900 may be, for example, a mobile telephone, personal digital assistant, e-book reader, tablet computer, or the like, and may include a number of components and features that are omitted for clarity. It will be further understood that, for convenience of illustration, the relative size of certain components has been distorted. Ordinarily, for example, driver circuit 920 and ALS 910 may be smaller, relative to display 940, for example, than is actually presented in FIGS. 9A and 9B. PED 900 may include frame 950, cover class 930, display 940, ALS 910 and driver circuits 920. One or more of driver circuits 920 may provide functionality similar to array driver 22, row driver circuit 24 and/or column driver circuit 24 described herein above. Display 940 may be an IMOD display, another type of reflective display device, or a non-reflective display, such as a thin film transistor (TFT) liquid crystal display. In the illustrated implementation, a single display 940 is illustrated; in some implementations, however, PED 900 may include two or more displays 940, which may or may not be of the same type. Display elements of display 940 are communicatively coupled with, and driven by, one or more of driver circuits 920. Although four driver circuits 920 are illustrated, a smaller or greater number of driver circuits 920 are within the contemplation of the present disclosure.

ALS 910 may include at least one photosensitive device, such as a photodiode, for example, or other light sensing element that is sensitive to light having wavelengths within a certain region of the electromagnetic spectrum, for example, ambient visible light, IR radiation, near IR radiation, and/or UV radiation, and outputs a signal representative of at least one characteristic of the received light, for example, an intensity of received ambient light. As will be described in more detail herein below, ALS 910 may be configured to output signals that are indicative of ambient light spectrum ambient light direction.

Referring now to FIG. 9B, a partial section of PED 900 as viewed from direction AA is illustrated. It will be understood that PED 900 may ordinarily include a number of components omitted for clarity from FIG. 9B, including a back cover, a battery, a speaker and microphone, and other user input/output devices, for example. In the illustrated implementation, cover glass 930 is disposed within frame 950 and above display 940. Cover glass 930 may be fabricated from a glass, plastic or other substantially transparent material. Surface 932 (which may be referred to as the “front” or “exterior” surface) of cover glass 930 may define an exterior front surface of PED 900; in some implementations, however, a “top glass” (not shown) may be disposed over cover glass 930. Back surface 931 of cover glass 930 faces an interior portion of PED 900 and may be proximate to and parallel with a front surface of display 940.

In the illustrated implementation, driver circuits 920 and ALS 910 are each disposed proximate to back surface 931 of cover glass 930, within an annular region defined by an inner perimeter of frame 950 and outside an outer perimeter of display 940. Within this annular region, a substantially opaque artwork arrangement 935 may be disposed so as to prevent components disposed behind cover glass 930 and outside the perimeter of display 940 from being visible to a user. Artwork arrangement 935 may be disposed, as illustrated, proximate to a back surface 931 of cover glass 930 or proximate to front surface 932 of cover glass 930. In either case, it will be understood that small openings (not shown) in artwork arrangement 935 may be provided through which ALS 910 may receive ambient light.

The present inventor has appreciated that ALS 910 may, advantageously, be disposed behind cover glass 930, and not on the frame 950, nor within the perimeter of display 940. As a result, the overall dimension of PED 900 may be reduced. More particularly, a need to reserve mounting space for ALS 910 outside a perimeter of cover glass 930 (i.e., on frame 950), may be obviated. Moreover, the present techniques simplify electrical integration by avoiding a necessity to provide for electrical connection between a frame-mounted ALS and a cover-glass-mounted driver circuit. In addition to reducing the length of electrical connections required, when ALS 910 is disposed according to the present teaching, a need to run flex connections or other electrical wiring from, for example, a frame-mounted ALS to a glass mounted driver circuit may be obviated. As a result, a substantial savings in component and assembly costs may be realized.

Referring now to FIG. 9C, a simplified block diagram of an implementation is illustrated. In the illustrated implementation, driver circuit 920 is communicatively coupled with processor 21, ALS 910, and display 940. Responsive to signals 919 from processor 21, and signals 911 from ALS 910, driver circuit 920 controls at least a portion of display 940 by way of signals 921. Advantageously, signals 911 output from ALS 910 are indicative of an intensity, directionality and spectrum content of ambient light. Responsive to signals 911, driver circuit 920 may adjust or optimize display parameters. For example, driver circuit 920 may cause a color bias or luminescence of display 940 to be adjusted, responsive to characteristics of the ambient light detected by ALS 910. Alternatively, or in addition, driver circuit 920 may adjust an intensity or color of a frontlight (not illustrated). In some implementations, ALS 910 may also output signals 912 to processor 21 that are indicative of an intensity (or “level”), directionality and spectrum content of ambient light. Processor 21 may, in turn, adjust output signals 919 to cause driver circuit 920 to cause a color bias or luminescence of display 940 to be adjusted, responsive to characteristics of the ambient light detected by ALS 910. For example, processor 21 may adjust the color mapping between incoming color coordinates, (e.g., sRGB) and IMOD display color coordinates.

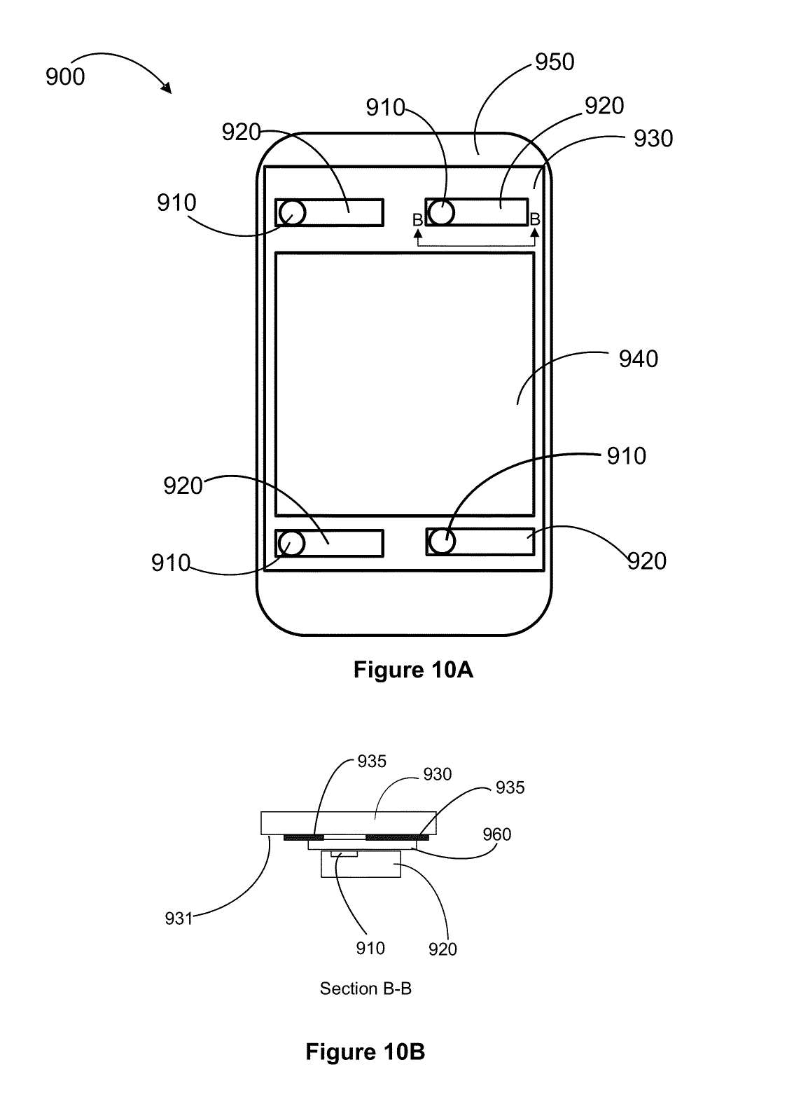

FIGS. 10A and 10B show an example of a PED in accordance with an implementation where an ALS is proximate to at least one of the driver circuits. Referring to FIG. 10A, in the illustrated implementation, each ALS 910 is proximate to a respective driver circuit 920. Advantageously, ALS 910 and driver circuit 920 may be integrated with or disposed on a single substrate (e.g., a single silicon substrate), which is disposed proximate to the back surface of cover glass 930. In the illustrated example, each of four ALS's 910 is disposed proximate to a respective driver circuit 920. However, more than one ALS 910 may be disposed proximate to a single driver circuit 920. Moreover, in some implementations at least some driver circuits 920 may not have an associated ALS 910.

Referring now to FIG. 10B, a partial section of driver circuit 920 integrated with ALS 910 as viewed from direction BB is illustrated. Driver circuit 920 may be configured with ALS 910 disposed between driver circuit 920 and back surface 931 of cover glass 930. In an implementation, driver circuit 920 and ALS 910 may have a common semiconductor substrate. Advantageously, driver circuit 920 and ALS 910 may be implemented as a monolithic integrated circuit. In one implementation, the integrated combination of driver circuit 920 and ALS 910 may be adhered to back surface 931 of cover glass 930 and/or artwork arrangement 935 by way of an anisotropic conductive film (ACF) 960. In an implementation, ACF 960 may have approximately 50% light transmittance. In some implementations, ALS 910 may be adhered to back surface 931 of cover glass 930 by way of wire bonding or be directly deposited on back surface 931.

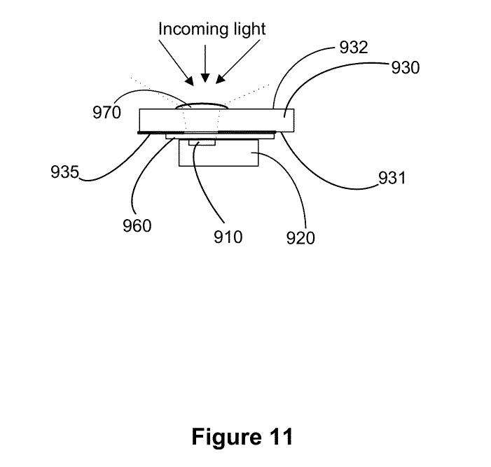

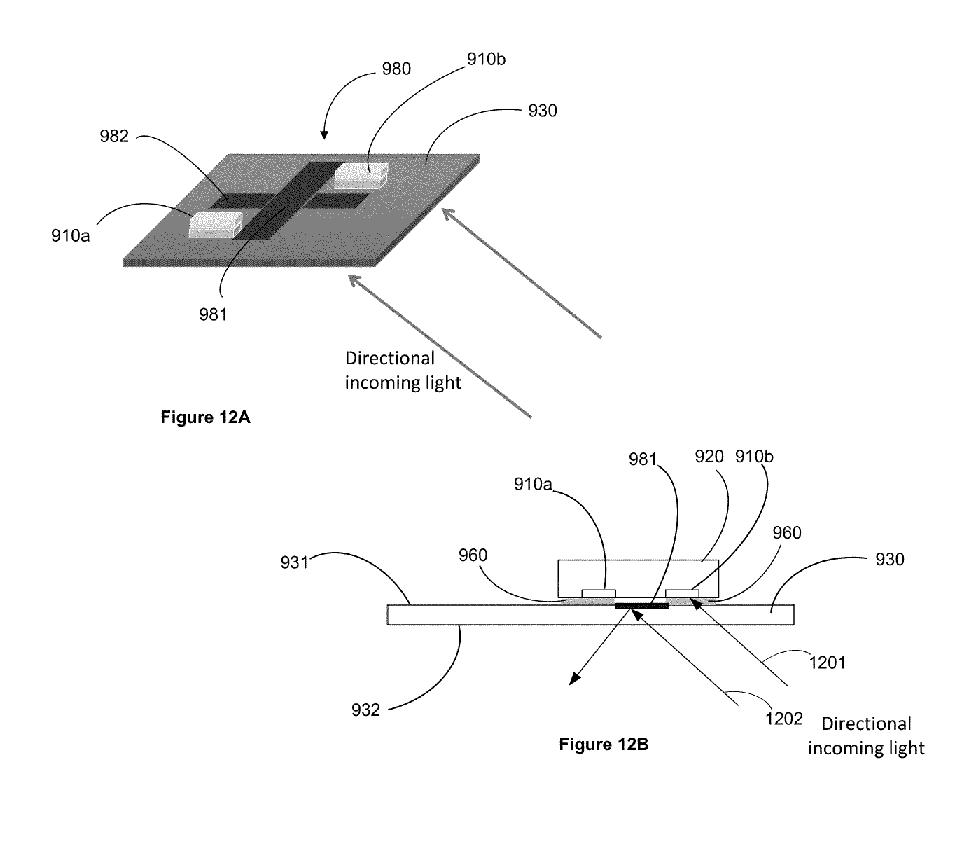

FIG. 11 shows an example of an implementation where an ambient light sensor is disposed behind a lens. In the illustrated implementation, lens 970 is disposed on front surface 932 of cover glass 930, however, other arrangements may be contemplated. For example, lens 970 may be embedded in cover glass 930. Moreover, lens 970 may be a collection of microlenses, for example. In one implementation, lens 970 may be configured so as to focus ambient light through cover glass 930, masking arrangement 935, and ACF 960 onto ALS 910. Advantageously, lens 970 may be configured to gather light from a wider half angle, for example, about 60 degrees, than would be possible in the absence of lens 970. As a result, a more representative sampling of the ambient light may be obtained. Moreover, as a result of operation of lens 970, efficiency of ALS 910 may be increased and a photosensitive element of a smaller size may be employed.

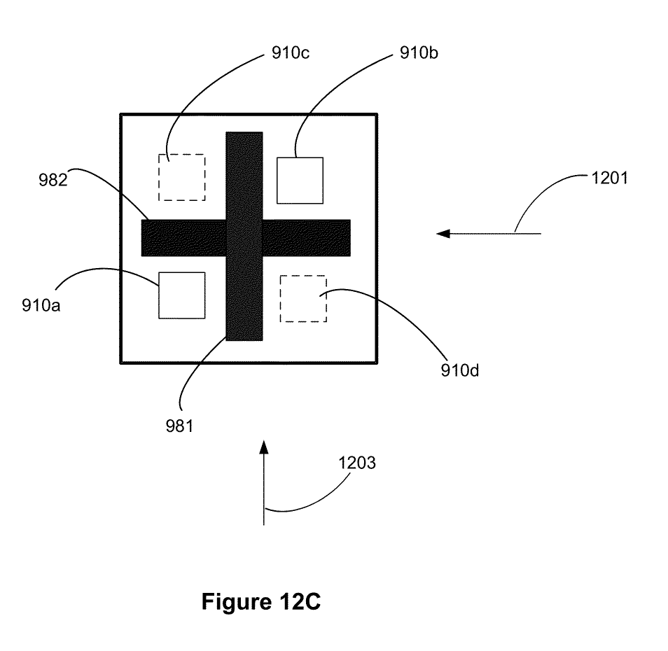

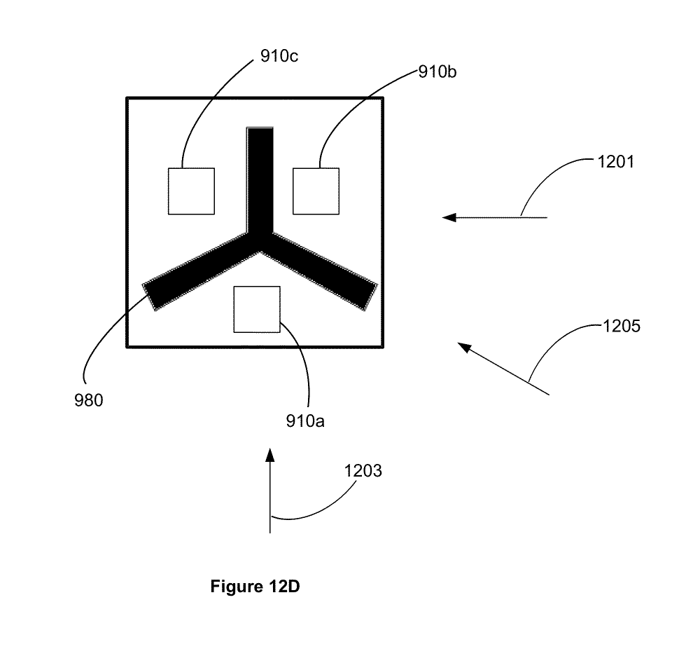

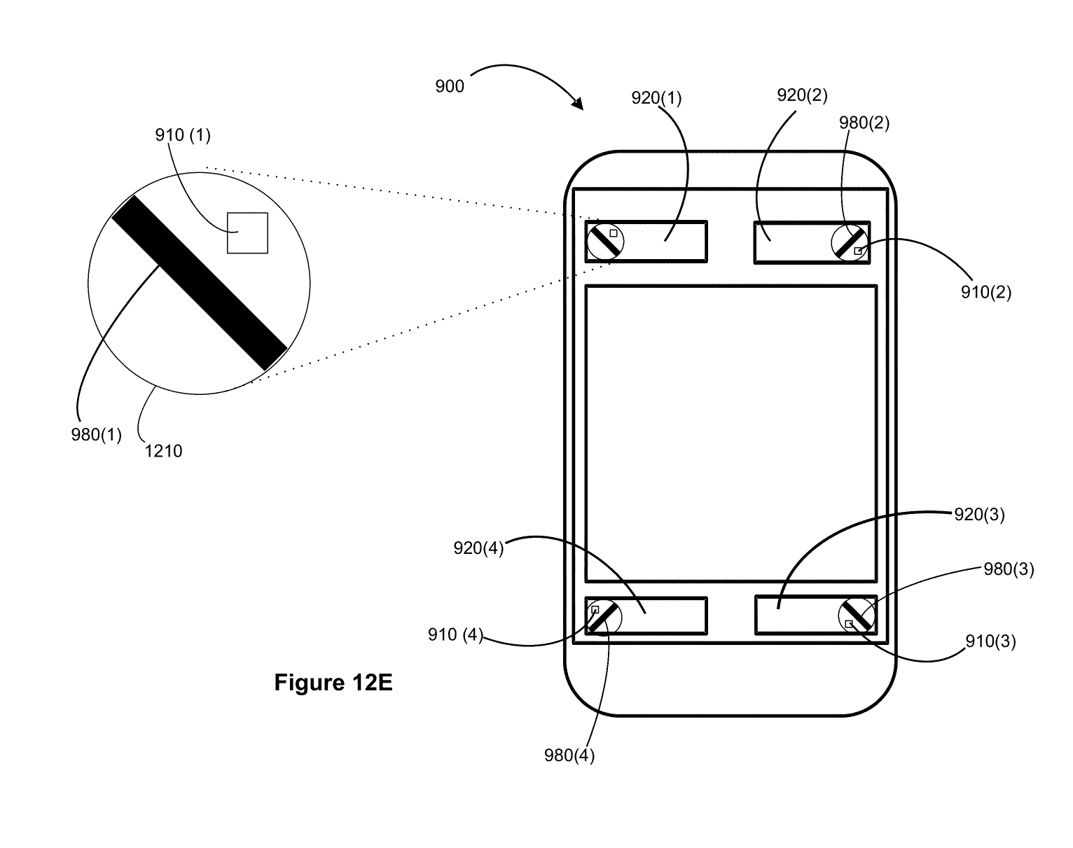

FIGS. 12A-12E show examples of implementations configured to detect a directionality of incoming light. Referring to FIGS. 12A, 12B and 12C, respectively, an isometric view, an elevation view and a plan view of a first example implementation is illustrated. A masking arrangement 980 is disposed proximate to two or more ALS 910 (identified as elements 910a and 910b). In the example implementation illustrated in FIGS. 12A and 12B, masking arrangement 980 includes a first mask element 981 and a second mask element 982, arranged in a cruciform arrangement. It will be understood, however, that masking arrangement 980 may be an integral device, not necessarily consisting of discrete parts. Moreover, first mask element 981 and second mask element 982 need not be respectively orthogonal or have identical dimensions. In the illustrated implementation, masking arrangement 980 is disposed on back surface 931 of cover glass 932. Alternatively, or in addition, however, masking arrangement 980, or elements thereof, may be disposed on front surface 932 of cover glass 932 or on a surface of a top glass (not illustrated), or as a layer within cover glass 932 or the top glass. Masking arrangement 980 may include, for example, a metallization layer within or on a surface of cover glass 932 or the top glass.

For simplicity of explanation, each element 910a and 910b may be referred to as an ALS. It will be understood, however, that elements 910a and 910b may, alternatively, be separate photosensitive regions of a single ALS 910. Advantageously, ALS 910a and 910b may be disposed proximate to or integrated with driver circuit 920 (omitted, for clarity, from FIGS. 12A and 12C).

Masking arrangement 980, advantageously, is configured such that, for ambient light having a first directional component 1201, first ALS 910a and second ALS 910b receive light of a substantially different intensity. For example, referring now to FIGS. 12A and 12B, directional incoming light 1201 may be received by ALS 910b after transmission through cover glass 930, ACF 960, and lens 970 (omitted, for clarity, from FIGS. 12A-E). In contrast, directional incoming light 1202, may be substantially blocked (reflected or scattered) by first mask element 981.

FIG. 12 B illustrates that a shadow produced by first mask element 981 results in a lesser amount of directional incoming light being received by ALS 910a than by ALS 910b. Similarly, referring now to FIG. 12C, a lesser amount of directional incoming light 1203 may be received by ALS 910b than by ALS 910a. FIG. 12C also illustrates that two additional ALS 910c and 910d (or two additional photosensitive regions of a single ALS) may be provided. Thus, in the implementation depicted in FIGS. 12A-C, masking arrangement 980 is configured such that, for ambient light having a first directional component, ALS 910a and ALS 910b receive light of a substantially different intensity.

It will be understood that the masking arrangement 980 may be configured in other ways than the cruciform arrangement illustrated in FIGS. 12A-C. A few further examples will now be described.

For example, referring now to FIG. 12D, masking arrangement 980 is illustrated as configured in a three legged star-like shape. A respective one of three ALS 910, may be disposed between each of three pairs of legs of masking arrangement 980. Masking arrangement 980, advantageously, is configured such that, for ambient light having a first directional component 1201, each of first ALS 910a, second ALS 910b, and third ALS 910c receive light of a substantially different intensity. Similarly, for ambient light having a second directional component 1203, first ALS 910a may receive light of a substantially different intensity than that received by second ALS 910b and third ALS 910c. Moreover, for ambient light having a third directional component 1205, third ALS 910c may receive light of a substantially different intensity than that received by first ALS 910a and second ALS 910b.

As a further example, referring now to FIG. 12E, an implementation is illustrated wherein each of four circuit drivers 920(1), 920(2), 920(3) and 920(4) has disposed thereon a respective ALS 910(1), 910(2), 910(3) and 910(4) and a respective masking arrangement 980(1), 980(2), 980(3) and 980(4). In the illustrated implementation, each masking arrangement may include a single linear strip, disposed, for example, diagonally so as to divide a light receiving aperture area 1210 approximately in half. Advantageously, each masking arrangement 980(i) and ALS 910(i) is disposed at a respectively different angular orientation. For example, in the implementation illustrated in FIG. 12E, masking arrangement 980(2) and ALS 910(2) are both disposed in an orientation in the plane of the drawing that is rotated 45 degrees from the orientation of masking arrangement 980(1) and ALS 910(1). Similarly, masking arrangement 980(3) and ALS 910(3) are both disposed in an orientation in the plane of the drawing that is rotated 45 degrees from the orientation of masking arrangement 980(2) and ALS 910(2), and masking arrangement 980(4) and ALS 910(4) are both disposed in an orientation in the plane of the drawing that is rotated 45 degrees from the orientation of masking arrangement 980(3) and ALS 910(3). As a result, for ambient light having a directional component, ALS 910(1), ALS 910(2), ALS 910(3), and ALS 910(4) may each receive light of a substantially different intensity.

From consideration of the example implementations illustrated in FIGS. 12A-E, it will be appreciated that, by appropriately configuring one or more masking arrangements 980 with respect to a number of photosensitive elements, aggregated signals output from the photosensitive elements may be caused to be indicative of a directionality of ambient light. More particularly, an elevation angle and an azimuthal angle of directional ambient light may be determined from the characteristics of signals output by the photosensitive elements. Based on the determined angle of directional ambient light, parameters of display 940 may, beneficially be adjusted, or optimized. For example, a luminescence, color bias, and/or contrast may be adjusted according to the method described herein below.

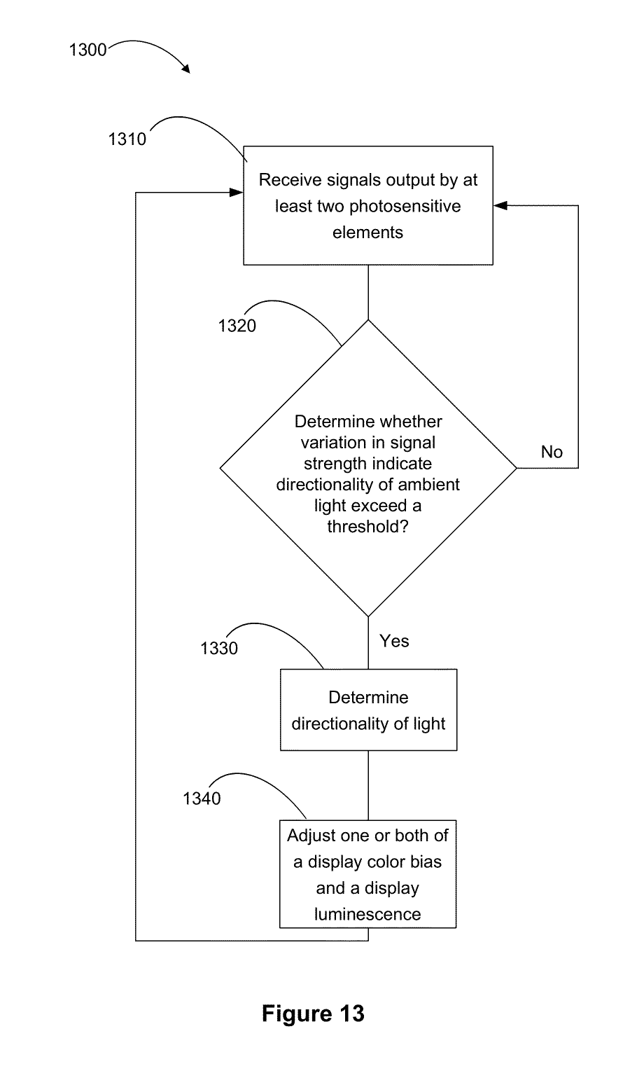

FIG. 13 shows an example of a method for adjusting a display parameter based on analysis of signals output from photosensitive elements. The signal analysis and display parameter adjustment method illustrated by FIG. 13 may be performed by driver circuit 920 based on calculations performed by, for example, processor 24. The method may begin at block 1310 with receiving, periodically or continuously, signals output by a number of photosensitive elements. The signals may be received from a single ALS 910 having multiple photosensitive elements, or from two or more ALS 910. In either case, as a result of an arrangement along the lines of those illustrated in FIGS. 12A-E, the signals output from the photosensitive elements will have characteristics which vary deterministically according to the strength and directionality of the received ambient light.

To the extent that the ambient light has a significant directional component, a statistically significant variation in signals output from the ALS's 910 may be expected. On the other hand, if the ambient light is relatively diffused (i.e., lacks a substantial directional component) the signals output from the photosensitive elements may exhibit relatively slight variation. Taking the foregoing into account, at block 1320, a determination may be made as to whether a variation in signal characteristics received from the photosensitive elements indicates that the directionality of ambient light exceeds a threshold. Advantageously, the threshold may be set to such a value that variations in ambient light directionality that are significant enough to effect a user's perception of display quality, result in a determination to make a compensating adjustment to a parameter of the display, as explained below.

The threshold may be predefined and/or fixed; however in some implementations, the threshold may be adjustable based on other ambient conditions (e.g., general levels of ambient conditions such as natural daylight, dark, indoor or outdoor artificial illumination, and/or rate of change of those ambient conditions) and/or user preferences. If at block 1320, a determination is made that the variation in signal characteristics indicates that directionality of ambient light does not exceed the threshold, the method may return to block 1310, either immediately, or after an interval of time.

On the other hand, if a determination is made that the variation in signal characteristics indicates that directionality of ambient light exceeds the threshold, the method may proceed to block 1330. At block 1330, the directionality of the ambient light is determined, at least approximately. The determination may be made by comparing the characteristics of signals received from ALS 910 or photosensitive elements thereof. As described hereinabove, an intensity of light received by each ALS 910 will vary substantially as a function of the direction of directional ambient light and the respective geometric arrangement of each ALS 910 with a nearby masking arrangement 980. It will be appreciated that, given knowledge of the respective geometry of each ALS 910 and its nearby masking arrangement 980, the variation can be used to determine, for example, the azimuthal and elevation angle of the directional component of ambient light with respect to display 940.

Based on the determination of block 1330, one or both of a display color bias and a display luminescence may be adjusted in block 1340. This is advantageous, particularly for a reflective display, for which an image quality may be significantly influenced by the incoming angle of directional ambient light. For example, in the case of an IMOD display, the perception of color, realized by interferometric behavior of the etalon, is sensitive to direction and wavelength of ambient light. In instances where the ambient light is highly directional, the color primaries of the display may change. Knowing this behavior, where the directional component is measured in accordance with the present teachings, color processing parameters of the display can be adjusted to correct for this phenomenon. Following the adjustment, the method may return to block 1310, either immediately, or after an interval of time.

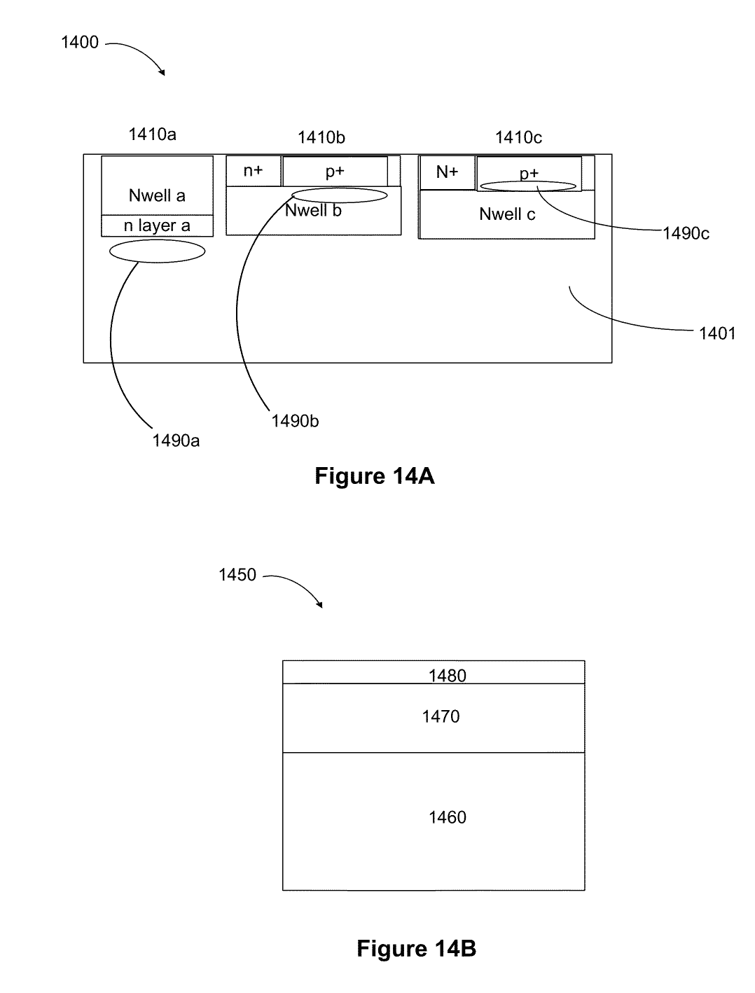

FIGS. 14A and 14B show examples of an implementation of an ALS configured to detect a spectrum characteristic of ambient light. In the implementation illustrated in FIG. 14A, ALS 1400 may include multiple photodiodes that may each be “tuned” such that each photosensitive element has a different respective sensitivity to a respective spectrum of electromagnetic radiation. The multiple photodiodes may each be disposed on single p-type substrate 1401, for example. In the illustrated implementation, for example, photodiodes 1410a, 1410b, and 1410c are each configured with a respective depletion region 1490a, 1490b, and 1490c at a depth appropriate for detection of a particular respective wavelength of light or a particular range of wavelengths of light. For example, photodiode 1410a may be configured such that Nwell ‘a’, associated with a high voltage transistor, for example a 16-20 volt transistor, is disposed above a deep buried n layer ‘a’ which is disposed above depletion region 1490a. In such an implementation, depletion region 1490a may be at a depth of approximately 3-5 μm, for example. As a result, photodiode 1410a may have a peak sensitivity to IR or near IR light. As a further example, photodiode 1410b may be configured such that a shallow n+ layer and a shallow p+ layer are disposed above Nwell ‘b’, associated with a high voltage transistor, for example a 16-20 volt transistor, with depletion region 1490b disposed within Nwell ‘b’, proximate to the shallow p+ layer. In such an implementation, depletion region 1490b may be at a depth of approximately 1-2 μm, for example. As a result, photodiode 1410b may have a peak sensitivity to green visible light. As a still further example, photodiode 1410c may be configured such that a shallow n+ layer and a shallow p+ layer are disposed above Nwell ‘c’, associated with a low voltage transistor, for example a 3-5 volt transistor, with depletion region 1490c disposed within the shallow p+ layer, proximate to Nwell ‘c’. In such an implementation, depletion region 1490c may be at a depth of approximately 0.5 μm, or less, for example. As a result, photodiode 1410c may have a peak sensitivity to blue visible light. A photodiode having a peak sensitivity to IR or near IR light, for example photodiode 1410a, may, advantageously, be used as part of an IR or near IR proximity sensor arrangement.

Although FIG. 14A depicts an arrangement wherein each photodiode is laterally separated from a neighboring photodiode, other arrangements are within the contemplation of the present disclosure. For example, referring now to FIG. 14B, an example of a layered sensor stack 1450 is illustrated. A height of stack 1450 may be approximately 5 μm, for example, and each of three stacked photodiodes, 1460, 1470 and 1480 may be configured to respond to a different respective wavelength of light. For example, photodiode 1480, disposed at the top of sensor stack 1450, may have a peak sensitivity to blue visible light. Photodiode 1460, disposed at the bottom of sensor stack 1450, may have a peak sensitivity to red visible light, IR or near IR light. Photodiode 1470, disposed between photodiode 1460 and photodiode 1480, may have a peak sensitivity to green visible light.

From consideration of the example implementation illustrated in FIG. 14, it will be appreciated that, by appropriately configuring the location of depletion regions for a number of photosensitive elements, aggregated signals output from the photosensitive elements may be caused to be indicative of a spectrum of ambient light. More particularly, at least an approximate characterization of ambient light spectrum may be determined from the signals output by the photosensitive elements. Based on the determined ambient light spectrum, parameters of display 940 may, beneficially be adjusted, or optimized. Thus, from analysis of the signals received by multiple photo sensitive elements 1410, spectrum information of received ambient light may be determined and a luminescence, color bias, and/or contrast of display 940 may be adjusted accordingly. In some implementations, ALS's having different combinations of photodiodes with different spectral sensitivity can be placed at different locations relative to the display 940 to optimize light sensing and/or proximity sensing.

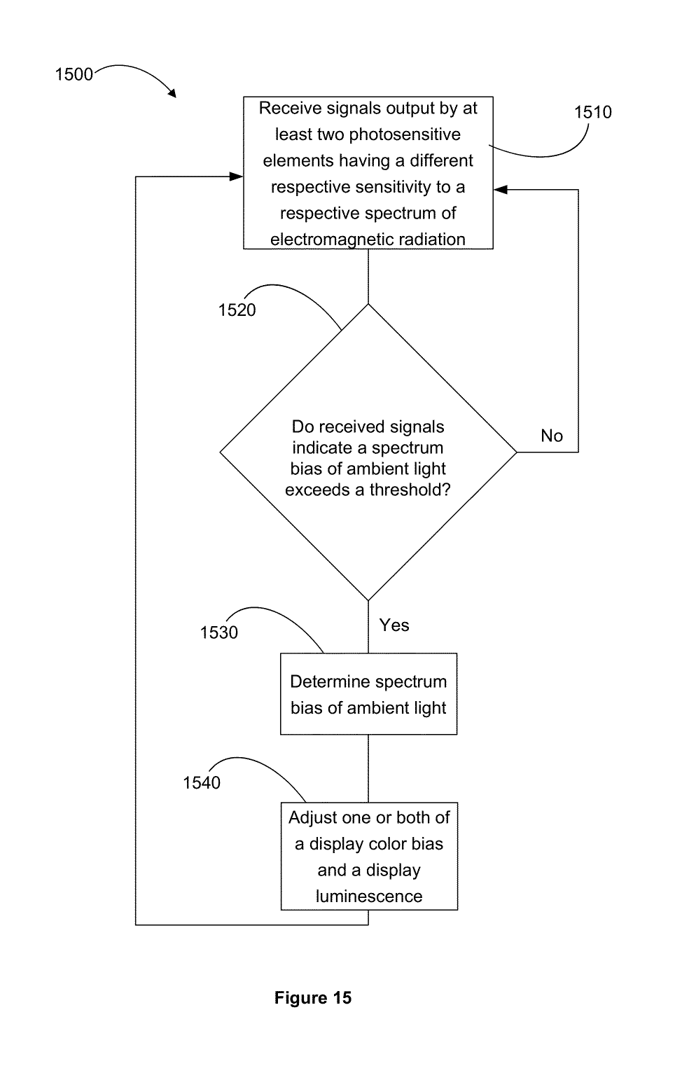

FIG. 15 shows an example of a method for adjusting at least one display parameter based on analysis of signals output from photosensitive elements configured to output signals indicative of a spectrum of incoming light. Advantageously, the adjustment is based on analysis of signals output from the multiple, respectively tuned photodiodes. The signal analysis and display parameter adjustment method illustrated by FIG. 15 may be performed by driver circuit 920 and/or processor 24.

The method may begin at block 1510 with receiving, periodically or continuously, signals output by at least two photosensitive elements having a different respective sensitivity to a respective spectrum of electromagnetic radiation. As a result of an arrangement along the lines of that illustrated in FIG. 14, the signals output from the photodiodes may have characteristics which vary deterministically according to the frequency spectrum of received ambient light.

To the extent that the ambient light has a significant spectrum bias, the respective photo diodes may exhibit a measurable variation from a nominal output signal. On the other hand, if the ambient light has a nominal spectrum (which may be defined, for example, in terms of a standard illuminant level, for example International Commission on Illumination (CIE) Standard Illuminant D65), the signals output from the photosensitive elements may exhibit a nominal output. Taking the foregoing into account, at block 1520, a determination may be made as to whether a spectrum bias of ambient light exceeds a threshold. Advantageously, the threshold may be set to such a value that variations in ambient light spectrum that are significant enough to effect a user's perception of display quality, result in a determination to make a compensating adjustment to a parameter of the display, as explained below.

The threshold may be predefined and/or fixed; however in some implementations, the threshold may be adjustable based on other ambient conditions (e.g., general levels of ambient conditions such as natural daylight, dark, indoor or outdoor artificial illumination, and rate of change of those ambient conditions) and/or user preferences. If, at block 1520, a determination is made that the spectrum bias of ambient light does not exceed the threshold, the method may return to block 1510, either immediately, or after an interval of time.

On the other hand, if a determination is made that the spectrum bias does exceed the threshold, the method may proceed to block 1530. At block 1530, the spectrum bias of the ambient light is determined, at least approximately. The determination may be made by analyzing the characteristics of signals received from each of multiple, respectively tuned photodiodes 1410. It will be appreciated that, given knowledge of the respective tuning parameters of each photodiodes 1410, signals therefrom can be used to determine the spectral bias of the ambient light.

Based on the determination of block 1530, one or both of a display color bias and a display luminescence may be adjusted, block 1540. This is advantageous, particularly for a reflective display, for which an image quality may be significantly influenced by the spectrum bias of ambient light. For example, for an IMOD display, an exhibited color results from a combination of incoming light and display reflection. Incandescent light sources, for example, have a low intensity of blue light, relative to sun light. In such ambient conditions, it may be advantageous to use, for example, a larger number of blue mirrors to get the same reflected intensity. Put another way, using the present teachings, a color mapping of the display may be changed, in some implementations, depending on the ambient light conditions. In some implementations, instead of, or in addition to changing the color mapping supplemental lighting (for example, a frontlight of the display) may be used and/or adjusted to compensate for the low intensity colors. As a result, colors that are not strong in the ambient spectrum may still be well rendered on the display. Following the adjustment, the method may return to block 1510, either immediately, or after an interval of time.

Advantageously, PED 900 may be configured to automatically adjust a luminescence of the display in response to a signal output by ALS 910. For example, in some implementations, ALS 910 is configured to output a signal to driver circuit 920 that is indicative of ambient light spectrum and/or ambient light direction. Advantageously, in such implementations, driver circuit 920 is configured to automatically adjust a luminescence and/or a color bias of display 940 in response to a signal output by ALS 910.

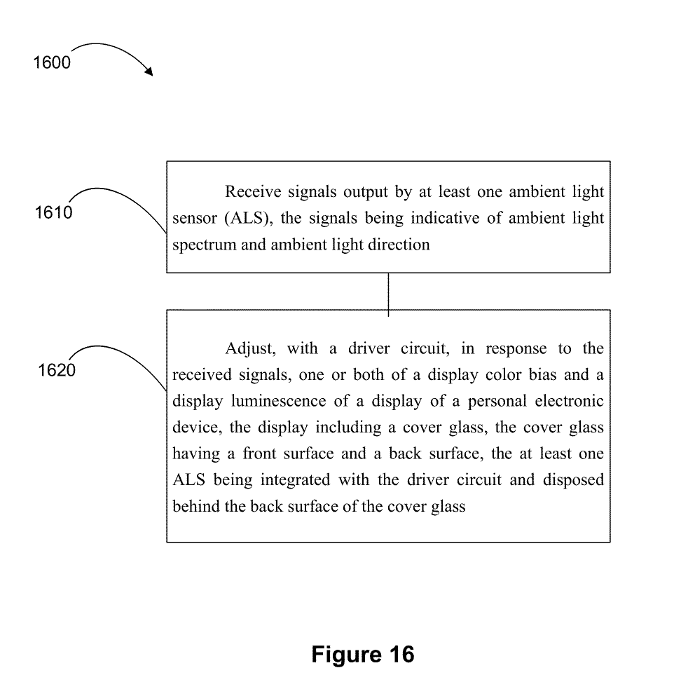

FIG. 16 shows an example of a method for adjusting a display color bias and/or display luminescence of a display of a PED. Method 1600 may begin at block 1610. Signals may be received from at least one ALS. The signals may be received, for example, by a driver circuit for a display of the PED and/or a PED processor. The signals may be representative of ambient light spectrum and ambient light direction.

At block 1620, one or both of a display color bias and a display luminescence may be automatically adjusted by the driver circuit, in response to the received signals. In the illustrated implementation, the display has a cover glass having a front surface and a back surface, and, advantageously, the at least one ALS is integrated with the driver circuit and disposed behind the back surface of the cover glass. The automatic adjustment of the display may be performed in accordance with method 1300 and/or method 1500 described herein above. As a result, advantageously, a display parameter such as color bias and/or display luminescence may be adjusted thereby preventing degradation of image quality that might otherwise be adversely influenced by a directional component or spectral bias of ambient light.

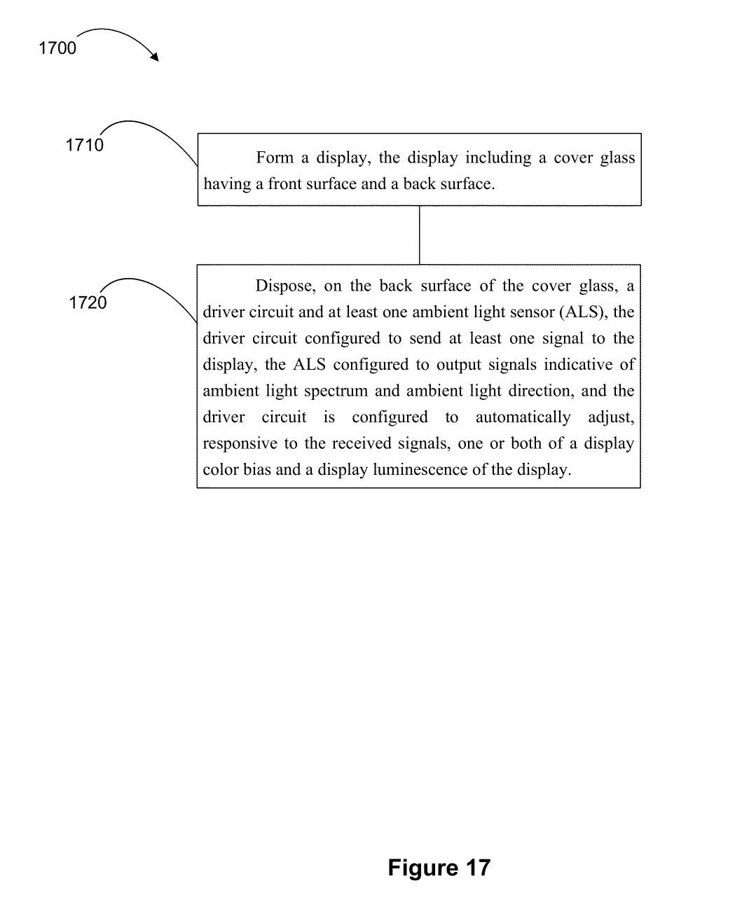

FIG. 17 shows an example of a method for fabricating a display. Method 1700 may begin at block 1710 wherein a display is formed, the display including a cover glass having a front surface and a back surface.

At step 1720 a driver circuit and at least one ALS may be disposed on the back surface of the cover glass. The driver circuit may be configured to send at least one signal to the display. The ALS may be configured to output signals indicative of ambient light spectrum and ambient light direction. Advantageously, the driver circuit and the ALS may have a common semiconductor substrate and be disposed proximate to the back surface of the cover glass. Advantageously, the driver circuit and the ALS may be implemented as a monolithic integrated circuit. In one implementation, the driver circuit may be adhered to the back surface of the cover glass by way of an anisotropic conductive film. Advantageously, the ALS may include at least two photosensitive elements, each photosensitive element having a different respective sensitivity to a respective spectrum of electromagnetic radiation. For example the ALS may include multiple photodiodes that may each be “tuned” such that each photosensitive element has a different respective sensitivity to a respective spectrum of electromagnetic radiation, as described hereinabove and illustrated in FIG. 14. As a result, aggregated signals output from the photosensitive elements may be caused to be indicative of a spectrum of ambient light. More particularly, at least an approximate characterization of ambient light spectrum may be determined from the signals output by the photosensitive elements.

Moreover, a first ALS and a second ALS may each be disposed proximate to at least one mask element, the mask element configured such that, for ambient light having a first directional component, the first ALS and the second ALS receive light of a substantially different intensity. The at least one mask element, advantageously, may be configured as illustrated in FIGS. 12A-E, and described hereinabove.

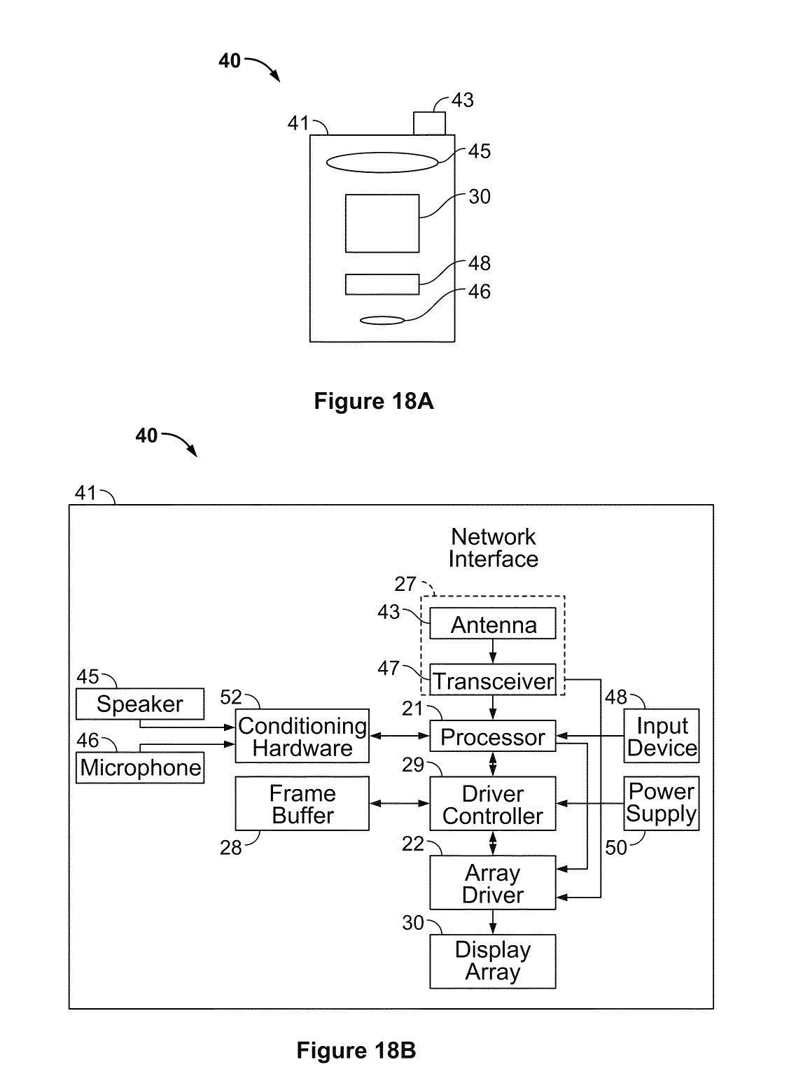

FIGS. 18A and 18B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 18B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A personal electronic device (PED) comprising:
a display, the display including a cover glass having a front surface and a back surface;
a processor that is configured to communicate with the display, the processor being configured to process image data;
a driver circuit configured to send at least one signal to the display; and
at least one ambient light sensor (ALS), wherein:
each of the driver circuit and the ALS is disposed behind the back surface of the cover glass, and
the ALS outputs signals to one or both of the driver circuit or the processor, the signals being indicative of ambient light level and one or both of ambient light spectrum, and ambient light direction.

2. The PED of claim 1, wherein the ALS and the driver circuit reside on a single substrate disposed proximate to the back surface of the cover glass.

3. The PED of claim 2, wherein the ALS is monolithically integrated with the driver circuit.

4. The PED of claim 3, wherein an anisotropic conductive film adheres the driver circuit to the back surface of the cover glass.

5. The PED of claim 1, wherein one or both of the driver circuit and the processor is configured to automatically adjust, in response to the signals, one or both of a display color bias and a display luminescence.

6. The PED of claim 1, wherein the ALS includes at least two photosensitive elements, each photosensitive element having a different respective sensitivity to a respective spectrum of electromagnetic radiation.

7. The PED of claim 6, wherein each of the at least two photosensitive elements are respectively tuned for sensitivity to a respective spectrum of electromagnetic radiation by way of a varied depth of a respective photodiode depletion region.

8. The PED of claim 8 wherein a first one of the at least two photosensitive elements is tuned to be sensitive to near-infra red (IR) radiation and a second one of the at least two photosensitive elements is tuned to be sensitive to a spectrum of visible light.

9. The PED of claim 1, wherein the PED includes at least a first ALS and a second ALS, each disposed proximate to at least one mask element, the mask element configured such that, for ambient light having a first directional component, the first ALS and the second ALS receive light of a substantially different intensity.

10. The PED of claim 9, wherein the PED includes a first mask element, and a second mask element, disposed in a cruciform arrangement in a first plane substantially parallel to the back surface of the cover glass, the plane disposed so that a beam of incoming ambient light must cross the plane before reaching the first ALS or the second ALS.

11. The PED of claim 9, wherein the PED includes a third ALS, a first mask element, a second mask element, and a third mask element disposed in a three legged star arrangement in a first plane substantially parallel to the back surface of the cover glass, the plane disposed so that a beam of incoming ambient light must cross the plane before reaching the first ALS, the second ALS, or the third ALS.

12. The PED of claim 1, wherein the PED includes at least a first ALS, a second ALS, and a third ALS, each disposed proximate to at least one respective mask element, the mask element configured such that, for ambient light having a first directional component, at least two of the first ALS, the second ALS, and the third ALS receive light of a substantially different intensity.

13. The PED of claim 1, further comprising:
a memory device that is configured to communicate with the processor.

14. The PED of claim 13, further comprising:
a controller configured to send at least a portion of the image data to the driver circuit.

15. The PED of claim 13, further comprising:
an image source module configured to send the image data to the processor.

16. The apparatus of claim 15, wherein the image source module includes one or more of a receiver, transceiver, and transmitter.

17. The apparatus of claim 13, further comprising:
an input device configured to receive input data and to communicate the input data to the processor.

18. An apparatus comprising:
means for receiving signals output by at least one ambient light sensor (ALS), wherein the signals are indicative of ambient light level and one or both of ambient light spectrum and ambient light direction; and
a driver circuit configured to send at least one signal to a display and to automatically adjust, in response to the received signals, one or both of a display color bias and a display luminescence of the display, the display including a cover glass, the cover glass having a front surface and a back surface; wherein
each of the driver circuit and the ALS is disposed behind the back surface of the cover glass.

19. The apparatus of claim 18, wherein the ALS and the driver circuit reside on a single substrate disposed proximate to the back surface of the cover glass.

20. The apparatus of claim 19, wherein the at least one ALS is monolithically integrated with the driver circuit.

21. The apparatus of claim 20, wherein an anisotropic conductive film adheres the driver circuit to the back surface of the cover glass.

22. The apparatus of claim 18, wherein the ALS includes at least two photosensitive elements, each photosensitive element having a different respective sensitivity to a respective spectrum of electromagnetic radiation.

23. The apparatus of claim 22, wherein each of the at least two photosensitive elements are respectively tuned for sensitivity to a respective spectrum of electromagnetic radiation by way of a varied depth of a respective photodiode depletion region.

24. The apparatus of claim 18, wherein the PED includes at least a first ALS and a second ALS, each disposed proximate to at least one mask element, the mask element configured such that, for ambient light having a first directional component, the first ALS and the second ALS receive light of a substantially different intensity.

25. The PED of claim 24, wherein the PED includes a first mask element, and a second mask element, disposed in a cruciform arrangement in a first plane substantially parallel to the back surface of the cover glass, the plane disposed so that a beam of incoming ambient light must cross the plane before reaching the first ALS or the second ALS.

26. The PED of claim 24, wherein the PED includes a third ALS, a first mask element, a second mask element, and a third mask element disposed in a three legged star arrangement in a first plane substantially parallel to the back surface of the cover glass, the plane disposed so that a beam of incoming ambient light must cross the plane before reaching the first ALS, the second ALS, or the third ALS.

27. The PED of claim 18, wherein the PED includes at least a first ALS, a second ALS, and a third ALS, each disposed proximate to at least one respective mask element, the mask element configured such that, for ambient light having a first directional component, at least two of the first ALS, the second ALS, and the third ALS receive light of a substantially different intensity.

28. A method comprising:
receiving signals output by at least one ambient light sensor (ALS), wherein the signals are indicative of ambient light level and one or both of ambient light spectrum and ambient light direction; and
automatically adjusting, with a driver circuit, responsive to the received signals, one or both of a display color bias and a display luminescence of a display of a personal electronic device (PED), the display including a cover glass, the cover glass having a front surface and a back surface; wherein
the at least one ALS is integrated with the driver circuit and disposed behind the back surface of the cover glass.

29. The method of claim 28, wherein the PED includes at least two ALS, each having a different respective sensitivity to a respective spectrum of electromagnetic radiation.

30. The method of claim 28, wherein the PED includes at least a first ALS and a second ALS, each disposed proximate to at least one mask element, the mask element configured such that, for ambient light having a first directional component, the first ALS and the second ALS receive light of a substantially different intensity.

31. A method for fabricating a display, the method comprising
forming the display, the display including a cover glass having a front surface and a back surface;
disposing, on the back surface of the cover glass, a driver circuit configured to send at least one signal to the display and at least one ambient light sensor (ALS), wherein:
the ALS is configured to output signals indicative of ambient light level and one or both of ambient light spectrum and ambient light direction; and
the driver circuit is configured to automatically adjust, responsive to the received signals, one or both of a display color bias and a display luminescence of the display.

32. The method of claim 31, further comprising:
monolithically integrating the ALS with the driver circuit on a single substrate disposed proximate to the back surface of the cover glass.

33. The method of claim 32, further comprising:
adhering, with an anisotropic conductive film, the driver circuit to the back surface of the cover glass.

34. The method of claim 31, wherein the ALS includes at least two photosensitive elements, each photosensitive element having a different respective sensitivity to a respective spectrum of electromagnetic radiation.

35. The method of claim 31, wherein at least a first ALS and a second ALS, are each disposed proximate to at least one mask element, the mask element configured such that, for ambient light having a first directional component, the first ALS and the second ALS receive light of a substantially different intensity.
